(19) United States
(12) Patent Application Publication
(10) Pub. No.: US 2025/0178093 A1
(43) Pub. Date: Jun. 5, 2025

(54) METHOD AND SYSTEM FOR ADDITIVELY MANUFACTURING AN ARTICLE, AND METHOD FOR CONTROLLING AN ADDITIVE MANUFACTURING PROCESS

(71) Applicant: The Boeing Company, Arlington, VA (US)

(72) Inventors: Andrew M. Countryman, Wildwood, MO (US); Baily J. Thomas, Lake Saint Louis, MO (US); Andrew P. Simpson, Jerseyville, IL (US)

(73) Assignee: The Boeing Company, Arlington, VA (US)

(21) Appl. No.: 18/524,088

(22) Filed: Nov. 30, 2023

(51) Int. Cl. B22F 12/37; B22F 12/90; B33Y 10/00; B33Y 30/00; B33Y 50/02

(52) U.S. Cl. CPC B22F 12/37; B22F 12/90; B33Y 10/00; B33Y 30/00; B33Y 50/02

(57) ABSTRACT

A method for additively manufacturing an article includes providing a build substrate having a build surface and depositing a material onto the build surface. The build surface includes at least one of a positive and negative volume keying, and the deposited material conforms substantially to the keying and extends outwardly to define the geometry of the article being built.

### FIELD

The present description relates to the field of additive manufacturing. More specifically, the invention pertains to methods and systems for additively manufacturing an article using a rotating build substrate.

### BACKGROUND

In the evolving landscape of additive manufacturing, the use of a stationary build substrate has been foundational. These stationary substrates provide a consistent and stable base upon which layers of material are sequentially deposited, culminating in the creation of a three-dimensional object. The stationary nature of the substrate ensures repeatability and reliability in numerous additive manufacturing applications.

However, the static nature of these substrates imposes inherent design constraints. The static substrate approach is often limited in its ability to facilitate intricate, unconventional, or non-linear geometric configurations. This limitation inherently bounds the creative and functional potential of objects produced through additive manufacturing, restricting designers and engineers to a subset of the vast array of potential geometric possibilities.

In particular, the stationary substrate methodology struggles with designs that require varying orientations or continuous structures that deviate from the traditional layer-by-layer deposition. As a consequence, while many structures are achievable, there exists a notable subset of designs that remain elusive or sub-optimal when relying solely on stationary substrates.

Recognizing these limitations, innovators in the field have ventured into exploring alternative approaches, seeking to transcend the geometric constraints imposed by static substrates. While introducing a non-static substrate promises expanded design horizons, they are not without challenges. The introduction of dynamism into the build substrate, for instance, poses issues of synchronization, structural integrity, and consistent material deposition.

Accordingly, those skilled in the art continue with research and development in the field of additive manufacturing.

### SUMMARY

Disclosed are methods for additively manufacturing an article.

In one example, the disclosed method for additively manufacturing an article includes providing a build substrate having a build surface and depositing a material onto the build surface. The build surface includes at least one of a positive and negative volume keying, and the deposited material conforms substantially to the keying and extends outwardly to define the geometry of the article being built.

In another example, the disclosed method for additively manufacturing an article includes providing a build substrate having a longitudinal axis and build surface, rotating the build substrate about its longitudinal axis, and depositing a material onto the build surface. The build surface includes at least one of a positive and negative volume keying, and the deposited material conforms substantially to the keying and extends outwardly to define the geometry of the article being built.

Also disclosed are systems for additively manufacturing an article.

In one example, the disclosed system for additively manufacturing an article includes a build substrate, a rotary actuator, a deposition head, and a controller. The build substrate has a longitudinal axis and build surface. The build surface includes at least one of a positive and negative volume keying. The rotary actuator is operatively connected to the build substrate. The deposition head is positioned relative to the build substrate for depositing a material onto the build surface. The controller is operatively connected to the rotary actuator and the deposition head. The controller is configured to synchronize the rotation of the build substrate with the deposition of material to achieve the desired article geometry.

Also disclosed are methods for controlling an additive manufacturing process.

In one example, the disclosed method for controlling an additive manufacturing process includes receiving data pertaining to a desired geometry of an article, determining a rotation speed and deposition rate based on the received data; instructing a rotary actuator to rotate a build substrate having a longitudinal axis and a build surface that includes at least one of a positive and negative volume keying, based on the determined rotation speed, and instructing a deposition head to deposit material onto the build surface in synchronization with the rotation of the build substrate, such that the deposited material conforms substantially to the keying and defines the desired geometry of the article.

Other examples of the disclosed methods and systems will become apparent from the following detailed description, the accompanying drawings and the appended claims.

### BRIEF DESCRIPTION OF THE DRAWINGS

FIG. 1 is a flow diagram illustrating the steps of a method for additively manufacturing an article.

FIG. 2 is an exemplary schematic of an additive manufacturing system featuring components such as a build substrate with at least one of positive and negative volume keying, a rotary actuator, a deposition head, an optional linear actuator, and a controller for synchronizing operations for article formation.

FIG. 3 is a depiction of the positive volume keying configuration on the build substrate, showing a raised ridge pattern.

FIG. 4 is a zoomed-in perspective of the positive volume keying shown in FIG. 3, demonstrating in greater detail the raised ridge pattern.

FIG. 5 is a depiction of another positive volume keying configuration on the build substrate, showing a single raised feature.

FIG. 6 is a depiction of another positive volume keying configuration on the build substrate, showing the positive volume keying on only a portion of the build surface.

FIG. 7 is a depiction of the negative volume keying configuration on the build substrate, showing an interwoven groove pattern.

FIG. 8 is a zoomed-in perspective of the negative volume keying shown in FIG. 7, demonstrating in greater detail the interwoven groove pattern.

FIG. 9 is a depiction of another negative volume keying configuration on the build substrate, showing a single depression.

FIG. 10 is a depiction of another negative volume keying configuration on the build substrate, showing the negative volume keying on only a portion of the build surface.

FIG. 11 is a depiction of a build substrate that includes both positive and negative volume keying configurations.

FIG. 12 represents a flow diagram of a method employed to control the additive manufacturing process, detailing steps from receiving design data to depositing material in synchronization with substrate rotation, utilizing either the positive or negative volume keying techniques.

### DETAILED DESCRIPTION

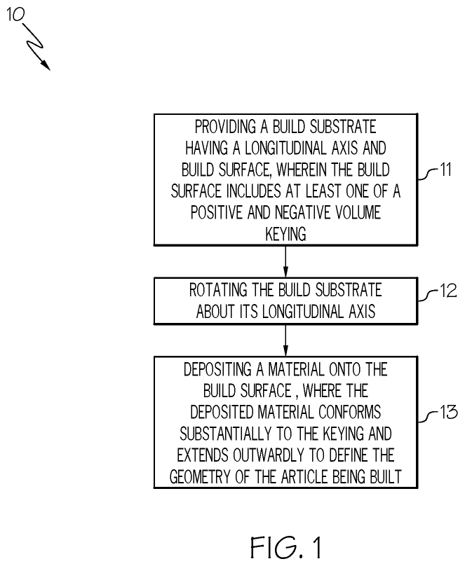

Referring to the flow diagram of FIG. 1, the present description relates to a method (10) for additively manufacturing an article, comprising: providing (11) a build substrate having a longitudinal axis and a build surface, wherein the build surface includes at least one of a positive and negative volume keying; and depositing (13) a material onto the build surface, where the deposited material conforms substantially to the keying and extends outwardly to define the geometry of the article being built.

In one particular implementation, the method (10) further includes rotating (12) the build substrate about the longitudinal axis of the build substrate. The depositing (13) may then be performed while the build substrate is rotating (12) about the longitudinal axis.

Conventional additive manufacturing processes typically employ a stationary build substrate. In these traditional systems, layers of material are typically deposited on top of one another to create a three-dimensional object. The substrate remains static during the build, serving as a base upon which the material is added.

The concept of additive manufacturing with a rotating build substrate introduces a dynamic approach. By rotating the substrate, it allows for a more diverse range of geometries to be achieved. While various additive manufacturing techniques can leverage this rotating platform, one notable method is Laser Blown Powder-Direct Energy Deposition (LBP-DED). This technique involves the focused application of energy to melt and fuse material as it is being deposited.

Utilizing a rotating build substrate opens up possibilities for intricate geometric configurations, including helical structures, which may be difficult or impossible to achieve with a stationary substrate.

However, introducing rotation also presents challenges. One of the primary obstacles is the need to maintain precise synchronization between the position and rotation of the substrate (e.g., metallic material) and the deposition of material (e.g., same or different metallic material). This coordination ensures the accuracy and quality of the printed object.

A major concern in additive manufacturing, especially when depositing metals with laser freeform techniques like LBP-DED, is the issue of residual stresses and thermal growth. Residual stresses can arise due to a mismatch in the coefficient of thermal expansion (CTE) between the build substrate and the deposited material. When these stresses accumulate, they can cause deformations or even cracks in the manufactured part.

When incorporating a rotating build substrate, these challenges related to residual stresses and thermal growth are compounded. The force of rotation can lead to the delamination of the partially printed part from the substrate. This not only interrupts the printing process, but can also damage equipment if not properly managed.

Some approaches to mitigate these problems include reducing the rotation speed, reducing the deposition rate, and redesigning the part to decrease areas of high stress concentration. However, these solutions can be inefficient, compromising the speed and flexibility of the manufacturing process.

The present description introduces at least one of a positive and negative volume keying to the build surface to counter the challenges presented by the rotating build substrate. The inclusion of this positive or negative volume keying reduces the chances of delamination. Moreover, even if delamination does occur, this positive or negative volume keying restricts or minimizes the movement of the deposited material relative to the build substrate, ensuring the integrity of the additive manufacturing process.

Positive volume keying includes one or more protrusions on the build surface, wherein the deposited material conforms substantially to the positive volume keying, creating recesses in the deposited material. In some examples, positive volume keying can comprise of a single protrusion. In other examples, positive volume keying can include a plurality of protrusions. Conversely, negative volume keying includes one or more depressions in the build surface, wherein the deposited material conforms substantially to the negative volume keying, forming protrusions of deposited material into the depressions in the build surface. In some examples, negative volume keying can comprise of a single depression. In other examples, positive volume keying can include a plurality of depressions. Still in other examples, the build surface can comprise of both positive keying and negative keying in different surface areas of the build surface. In still other additional examples, the build surface can comprise of both positive keying and negative keying intermingled in the same surface area of the build surface.

A salient advantage of employing the positive or negative volume keying is the increase in the surface area of contact between the build surface and the deposited material. The increased surface area amplifies the force holding the deposited material to the build surface, effectively counteracting the force applied to the deposited material during the rotation of the substrate. This enhanced holding force, in turn, diminishes the risk of delamination during the additive manufacturing process.

Also, in the event of delamination, the positive or negative volume keying serves a secondary role. In scenarios involving negative volume keying, a portion of the deposited material extends into the depressions in the build surface. With positive volume keying, sections of the build surface protrude into the deposited material. In both scenarios, the interlocking of the deposition material with the positive or negative volume keying acts as a safeguard, preventing movement of the delaminated deposited material relative to the build substrate. This ensures that the alignment and precision between the deposition material and the substrate is maintained, even in delamination situations.

The configuration of the positive or negative volume keying plays a role in ensuring that movement is prevented in both longitudinal and circumferential directions during the additive manufacturing process. One approach to achieve this is by implementing multiple types of positive or negative volume keying—a first positive or negative volume keying designed to prevent movement in the longitudinal direction and a second positive or negative volume keying designed to restrict movement in the circumferential direction. For instance, the longitudinal positive or negative volume keying could be a straight groove or ridge aligned with the axis, while the circumferential positive or negative volume keying could be a circular groove or ridge wrapping around the build surface.

However, a more integrated design could involve a single positive or negative volume keying configuration that restricts movement in both directions simultaneously. For example, an “X”-shaped or “T”-shaped positive or negative volume keying can serve this dual purpose. These shapes provide resistance against forces acting along both axes, ensuring that the deposited material remains secured to the substrate irrespective of the direction of any applied stress.

The minimum depth of the positive or negative volume keying should be 0.003 in. or approximately 0.0762 mm. The significance of this depth lies in ensuring there's adequate material engagement to prevent movement of the deposited material. However, for build surfaces with larger radii or for parts that require additional strength, it might be beneficial to opt for a greater depth, such as 0.005 in. (0.127 mm) or more, or 0.008 in. (0.203 mm) or more. A deeper positive or negative volume keying can provide a more pronounced interlock, further diminishing the risk of material displacement.

In terms of width, the positive or negative volume keying should have a minimum width of 0.005 in. or approximately 0.127 mm. A wider positive or negative volume keying can offer enhanced resistance to shear forces and may be useful when working with deposited materials or substrates that possess lower tensile strength. Depending on the properties of the materials in use, the width can be increased to 0.007 in. (0.1778 mm) or 0.010 in. (0.254 mm).

Additionally, the minimum depth and width of the positive or negative volume keying should be equivalent to, or surpass, the predetermined layer height and width of the additive manufacturing process. This ensures that, during deposition, the material adequately fills or conforms to the positive or negative volume keying features, enabling a secure engagement between the substrate and the deposited material. Variations in the additive manufacturing technique might necessitate adjustments to the positive or negative volume keying dimensions to accommodate for different layer heights and widths.

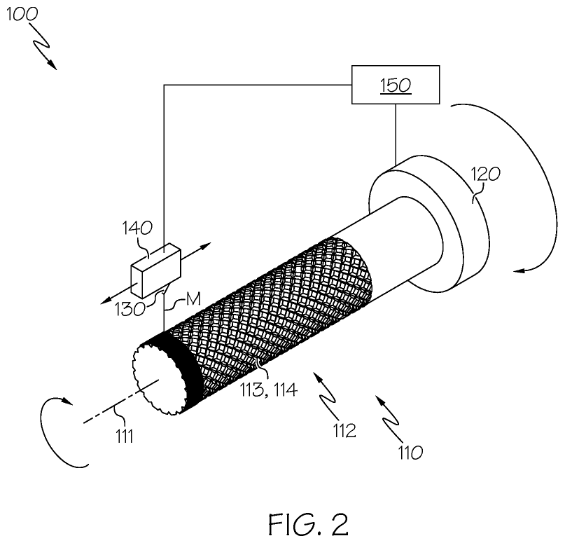

FIG. 2 is a representation of an exemplary system (100) for additively manufacturing an article. While the exemplary system (100) is described with reference to specific components including a build substrate (110), a rotary actuator (120), a deposition head (130), an optional linear actuator (140), and a controller (150), the system is exemplary. Alternative systems for practicing the method for additively manufacturing an article may encompass other variations, modifications, and alternative or additional components tailored to specific manufacturing requirements.

The build substrate (110) has a longitudinal axis (111) and build surface (112), wherein the build surface (112) includes at least one of a positive volume keying (113) and negative volume keying (114). Thus, the build surface (112) may incorporate either a positive volume keying (113), negative volume keying (114), or a combination of both. While depicted with a cylindrical cross-section, the build substrate could also adopt other shapes, such as a conical cross-section.

The rotary actuator (120) is operatively connected to the build substrate (110) to enable its rotation. Various types of rotary actuators, such as motor-driven systems, electromagnetic mechanisms, and piezoelectric actuators, can be employed depending on the system requirements. The choice of actuator depends on factors such as rotation speed, precision, and torque needs.

The deposition head (130) is positioned relative to the build substrate (110) for depositing a material (M) onto the build surface (110). The deposition process can be based on various techniques in additive manufacturing, one notable method is Laser Blown Powder-Direct Energy Deposition (LBP-DED). Depending on the chosen additive manufacturing method, the deposition head (130) may function in different ways. In the context of Laser Blown Powder-Direct Energy Deposition (LBP-DED), the deposition head (130) typically integrates a powder feeder that blows metal powder into a specific location, while a laser simultaneously melts the powder, ensuring it adheres to the build surface.

The linear actuator (140) is operatively connected to the deposition head (130) for moving the deposition head (130) along the build surface (112). Alternatively, a linear actuator (140) may be operatively connected to the build substrate (110) for moving the build substrate (110) relative to the deposition head (130). The linear actuator (140) may enable precise movement, ensuring accurate placement of the deposition head (130) relative to the build substrate (110) or vice versa. Various types of linear actuators can be incorporated, such as lead screw-driven systems, pneumatic actuators, or magnetic linear drives. The choice of a linear actuator is generally influenced by factors including movement precision, range of motion, speed, and the overall manufacturing process's specific requirements. In some advanced systems, multi-axis linear actuators might be employed to offer increased degrees of freedom, enhancing the ability to deposit material in complex geometries and patterns.

The controller (150) is operatively connected to the rotation actuator (120) and the deposition head (130). The controller (150) is configured to synchronize the rotation of the build substrate (110) with the deposition of material (M) to achieve the desired article geometry. The controller (150) may be a computing device or a system of integrated electronic components designed to manage, regulate, and coordinate the various operations within the additive manufacturing system. The controller may include a processor, memory, input/output interfaces, and various other electronic circuits. The memory stores instructions and parameters for the additive manufacturing process, while the processor executes these instructions to facilitate the desired interactions among the components of the system.

The primary role of the controller (150) is to synchronize the movements and operations of the components, particularly regulating the movement of the deposition head (130) in tandem with the rotation of the build substrate (110). If the deposition head (130) is statically positioned, the controller ensures the rotation speed of the build substrate (110) is adjusted accordingly. If the deposition head (130) is mobile, the controller communicates with the linear actuator (140) to move the deposition head (130) linearly across the rotating build surface (112). This movement ensures a distribution of material across the entirety of the build surface.

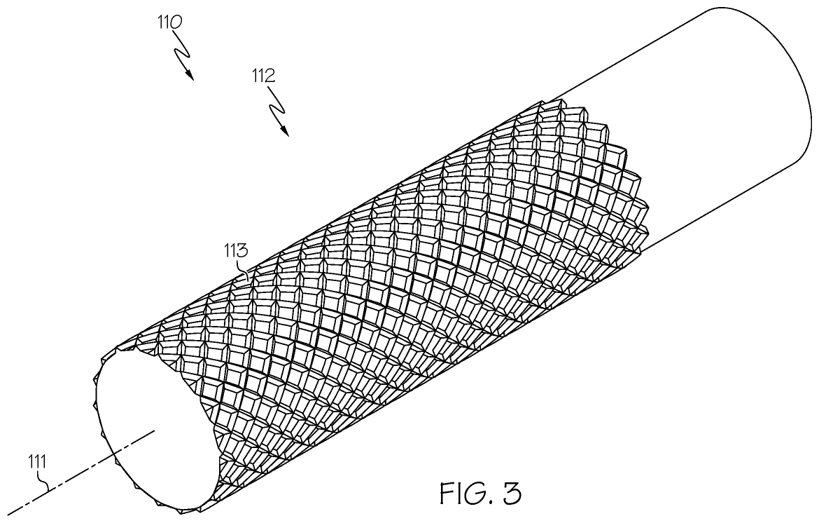

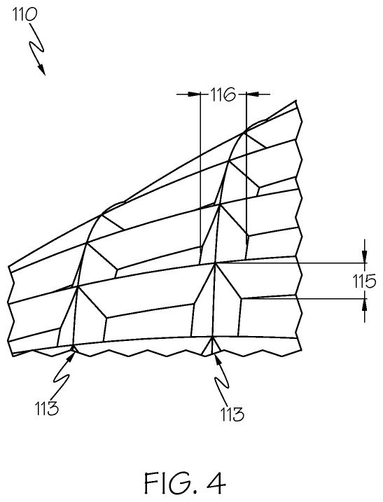

FIG. 3 is an exemplary build substrate having a build surface that includes a positive volume keying, and FIG. 4 is close up view of FIG. 3. Referring to the figures, the build substrate (100) is shown as a long cylindrical structure having a longitudinal axis (111). A first portion of the build substrate (100) is smooth and uniform, where a second portion has a build surface (112) shown as a distinct pattern. The pattern represents a positive volume keying (113), which is illustrated in the example as a pronounced mesh-like ridge pattern. In this example, the pattern comprises interwoven ridges creating diamond-shaped gaps between them, and, in the example, the pattern is consistent throughout.

The diamond-shaped gaps in the mesh-like pattern are recesses, surrounded by the protruding ridges that can constitute the positive volume keying (113). As material is deposited onto this region, the material flows around these protrusions, filling the diamond-shaped gaps and conforming to the shape of the positive volume keying (113). This ensures that the deposited material forms a strong mechanical interlock with the build surface (112) due to the presence of these interwoven ridges.

From the close-up view in FIG. 4, it is evident that the positive volume keying (113) not only promotes better adhesion between the deposited material and the build substrate but also provides an additional structural benefit by increasing the effective interference area. This increment in interference area, as described earlier, significantly reduces the risk of delamination.

In practice, as the build substrate (110) rotates and material is deposited, the rotation introduces forces that could potentially shear the deposited material away from the substrate. The mechanical engagement facilitated by the positive volume keying (113) counteracts these forces, maintaining a secure bond between the deposited material and the build substrate.

It is important to note that while the positive volume keying (113) is represented as a specific mesh-like pattern present throughout the entire build surface, numerous other patterns and configurations can be utilized, depending on the desired characteristics of the final part, the materials involved, and the specific challenges of the additive manufacturing process. In some examples, positive volume keying can comprise a single raised feature (e.g., a recess surrounded by ridges). In other positive keying examples, a plurality of raised features may be present on an angular portion of the build surface or on a lengthwise portion of the build surface.

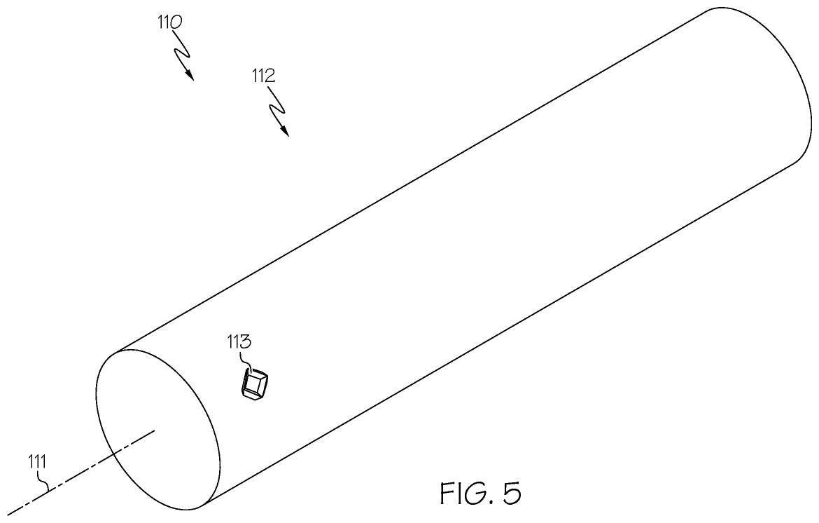

FIG. 5 is an exemplary build substrate having a build surface that includes a positive volume keying (113) that comprises a single raised feature, and wherein keying is not present on a remaining portion of the build surface. By limiting the keying to a single feature, this design may simplify the manufacturing process of the build substrate.

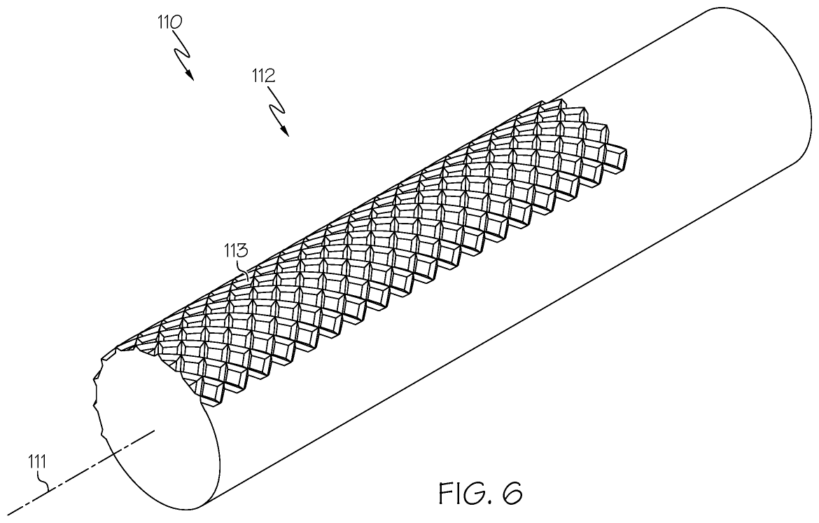

FIG. 6 is another exemplary build substrate having a build surface that includes a positive volume keying (113), in which the positive volume keying (113) is present on an angular portion of the build surface (112) and wherein keying is not present on a remaining angular portion of the build surface. This can be beneficial for parts that require additional support in specific angular regions.

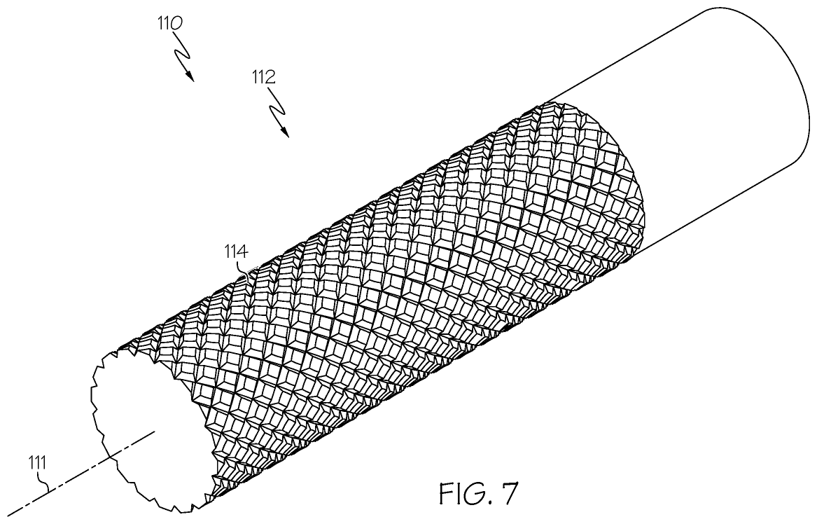

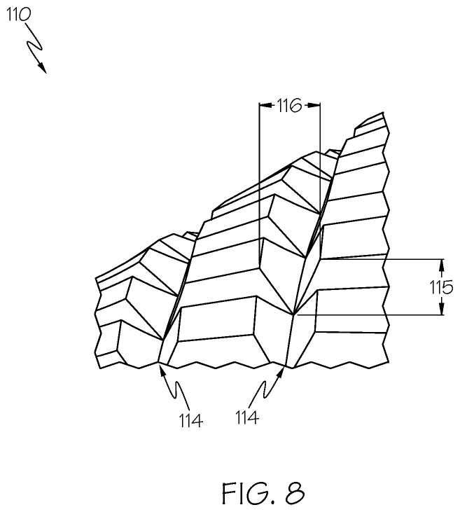

FIG. 7 is an exemplary build substrate having a build surface that includes a negative volume keying, and FIG. 8 is close up view of FIG. 7. Referring to the figures, the build substrate (100) is shown as a long cylindrical structure having a longitudinal axis (111). A first portion of the build substrate (100) is smooth and uniform, where a second portion has a build surface (112) shown as a distinct pattern. The pattern can represent a negative volume keying (113), which is illustrated in the example as a pronounced mesh-like groove pattern. In this example, the pattern comprises interwoven lines creating diamond-shaped gaps between them, and, in the example, the pattern is consistent throughout.

The diamond-shaped gaps in the mesh-like pattern are depressions, surrounded by the level regions of the build substrate that form the rest of the build surface (112). When material is deposited onto this area, the material flows into these depressions and conforms to the shape of the negative volume keying (114). The presence of these interwoven grooves ensures that the deposited material forms a strong mechanical bond with the build surface (112), enhancing the adhesion between the two.

The close-up view in FIG. 8 provides a clearer perspective on the negative volume keying (114) and its impact on the deposition process. The interlocking nature of the negative volume keying (114) amplifies the surface contact area between the deposited material and the build substrate, significantly minimizing the potential of delamination.

As with the positive volume keying described earlier, the purpose of these interwoven grooves is to counter the forces introduced by the rotation of the build substrate (110). This mechanical bonding ensures a secure connection between the deposited material and the substrate, regardless of the forces exerted due to the rotating movement.

It should be highlighted that while the negative volume keying (114) is depicted as a specific mesh-like pattern present throughout the entire build surface, numerous other configurations and patterns can be employed based on various factors. The specific design can be chosen considering the intended properties of the final product, the materials used, and the unique challenges posed by the additive manufacturing technique in use. In some examples, negative volume keying can comprise a single depression. In other negative keying examples, a plurality of depressions may be present on an angular portion of the build surface or on a lengthwise portion of the build surface.

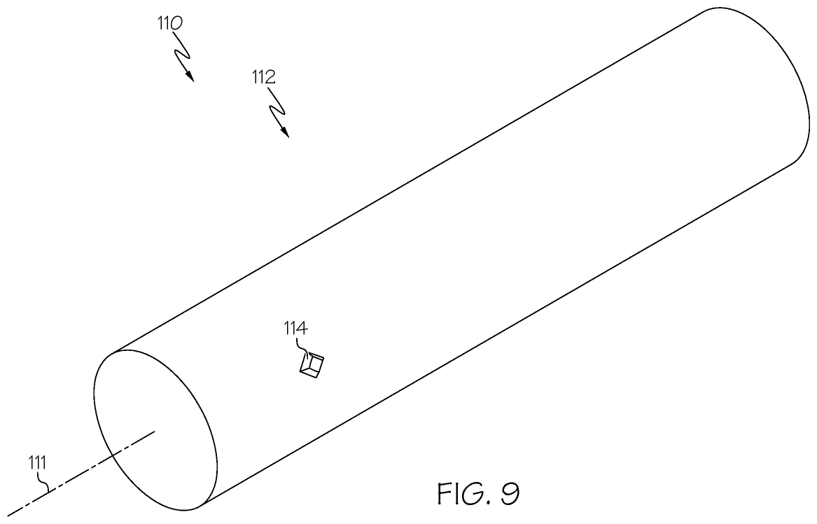

FIG. 9 is an exemplary build substrate having a build surface that includes a negative volume keying (114) that comprises a single depression, and wherein keying is not present on a remaining portion of the build surface. By limiting the keying to a single feature, this design may simplify the manufacturing process of the build substrate.

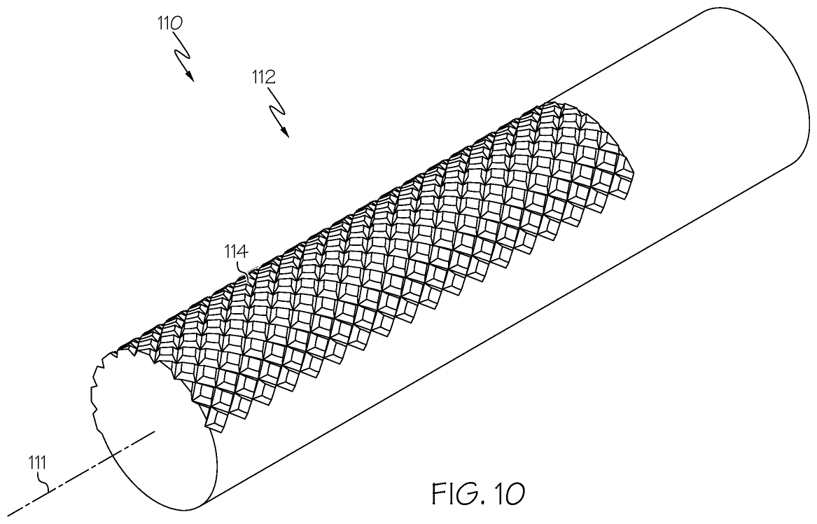

FIG. 10 is another exemplary build substrate having a build surface that includes a negative volume keying (114), in which the negative volume keying (114) is present on a lengthwise portion of the build surface (112) and wherein keying is not present on a remaining lengthwise portion of the build surface. This can be beneficial for parts that require additional support in specific angular regions.

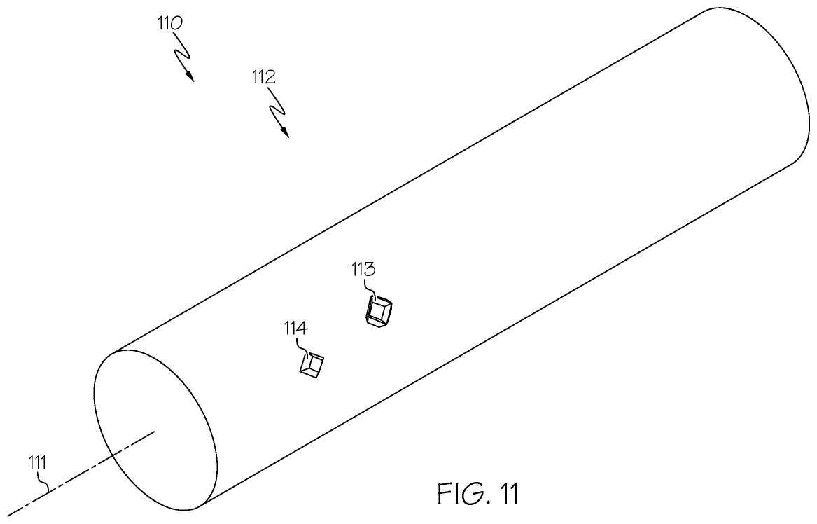

FIG. 11 is yet another exemplary build substrate having a build surface that includes both positive volume keying (113) and negative volume keying (114). The positive volume keying (113) includes one or more raised features, while the negative volume keying (114) includes one or more depressions. This dual keying approach potentially enhances the mechanical interlock and bond strength between the deposited material and the build substrate. Although FIG. 11 illustrates a configuration with a single raised feature and a single depression, the dual keying approach encompassing both positive volume keying (113) and negative volume keying (114) can be expanded into a multitude of configurations, including a plurality of raised feature and a plurality of depression, and including positioning the keying on entirety of the build surface or a portion of the build surface.

In addition to enhancing the bond between the deposited material and the substrate, the positive and negative volume keying configurations can also be influential in controlling the thermal characteristics of the deposition process. The increased surface area can lead to a more uniform heat distribution, which might assist in mitigating thermal stresses, reducing warping, and improving the overall quality of the printed part.

The utilization of positive or negative volume keying on the build substrate introduces a novel approach to enhancing the stability and reliability of additive manufacturing processes, especially those involving a rotating build substrate. This solution not only addresses the challenges posed by delamination but also presents a more efficient and reliable alternative to the conventional methods of merely altering deposition or rotation speeds. The described configurations and design considerations for the volume keying ensure performance and adaptability for a broad spectrum of additive manufacturing applications.

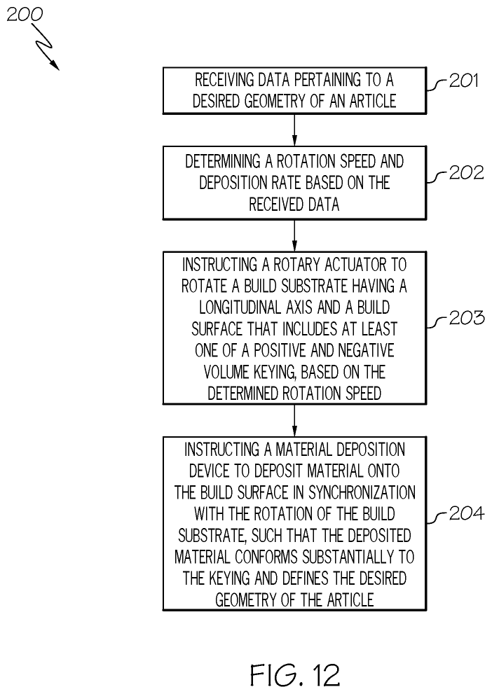

FIG. 12 describes a method (200) for controlling an additive manufacturing process. The method includes receiving (201) data pertaining to a desired geometry of an article; determining (202) a rotation speed and deposition rate based on the received data, instructing (203) a rotary actuator to rotate a build substrate having a longitudinal axis and a build surface that includes at least one of a positive and negative volume keying, based on the determined rotation speed, and instructing (204) a deposition head to deposit material onto the build surface in synchronization with the rotation of the build substrate, such that the deposited material conforms substantially to the keying and defines the desired geometry of the article.

The initial step is the receiving (201) of data related to the desired geometry of the article to be produced. This data can be in the form of computer-aided design (CAD) files, digital representations, or any other suitable format that describes the shape, dimensions, and intricacies of the intended article.

Based on the received data, the method determines (202) the rotation speed for the build substrate and the deposition rate for the material. This determination may take into account various factors such as the intricacy of the design, the material's properties, the heating/melting method, and any other pertinent variables that might influence the additive manufacturing process.

Once these rotation speed is determined, the rotary actuator is instructed (203) to rotate the build substrate according to the determined speed. The synchronization between the rotation of the substrate and the deposition of the material facilitates the precise and consistent construction of the intended article.

The next step involves instructing (204) the deposition head, like the LBP-DED deposition head, to deposit the material onto the build surface. This deposition occurs in tandem with the rotation of the build substrate. Due to the positive or negative volume keying on the build surface, the deposited material conforms substantially to this keying, ensuring a more stable bond between the substrate and the deposited material, and mitigating the risk of delamination. This step results in the creation of the article with the desired geometry, while also benefiting from the stability and reliability provided by the positive or negative volume keying.

After the article is formed, there may be additional post processing steps. Once the desired article has been printed, there may be additional steps to enhance its properties, improve its appearance, and ensure it meets the specified requirements. These steps can include cleaning, heat treatment, support removal, surface finish, machining, inspection and quality control, coating or painting, and assembly.

After the material deposition process, the article may still be attached to the build substrate. In an aspect, post-processing may include removing at least a portion of the build substrate not in direct contact with the deposited material, or removing at least a portion of the build substrate in direct contact with the deposited material.

For some applications, it may be necessary to remove at least a portion of the build substrate that is not in direct contact with the deposited material. This can be done for a variety of reasons. For instance, it might be a part of the design requirement where only a portion of the build substrate forms the final product. Techniques such as machining, laser cutting, or even manual tools can be employed to perform this detachment.

In other scenarios, removing at least a portion of the build substrate that is in direct contact with the deposited material might be desired. This can be done for a variety of reasons. For instance, it might be a part of the design requirement where only the deposited material forms the final product. Thus, the build substrate may be partially of completed removed from contact with the deposited material. For such cases, precision machining, ultrasonic cutting, or even other methods may be employed to remove the build substrate.

Although various examples of the disclosed methods and systems have been shown and described, modifications may occur to those skilled in the art upon reading the specification. The present application includes such modifications and is limited only by the scope of the claims.

1. A method for additively manufacturing an article, comprising:
providing a build substrate having a build surface, wherein the build surface includes at least one of a positive volume keying and a negative volume keying; and
depositing a material onto the build surface, where the material deposited onto the build surface substantially conforms to the at least one of the positive volume keying and the negative volume keying, and extends outwardly to define a geometry of the article being built.

2. The method of claim 1, wherein the build substrate has a cylindrical cross-section.

3. The method of claim 1, wherein the build surface includes a positive volume keying.

4. The method of claim 1, wherein the build surface includes a negative volume keying.

5. The method of claim 1, wherein a minimum depth of at least one of the positive volume keying and the negative volume keying is 0.003 in.

6. The method of claim 1, wherein a minimum depth of at least one of the positive volume keying and the negative volume keying is 0.005 in.

7. The method of claim 1, wherein a minimum depth of at least one of the positive volume keying and the negative volume keying is 0.008 in.

8. The method of claim 1, wherein a minimum width of at least one of the positive volume keying and the negative volume keying is 0.005 in.

9. The method of claim 1, wherein a minimum width of at least one of the positive volume keying and the negative volume keying is 0.007 in.

10. The method of claim 1, wherein a minimum width of at least one of the positive volume keying and the negative volume keying is 0.010 in.

11. The method of claim 1, wherein the material deposited onto the build surface comprises a metallic material.

12. The method of claim 11, wherein the build surface comprises a metallic material, wherein the metallic material of the build surface is different from the metallic material deposited onto the build surface.

13. The method of claim 1, wherein the positive volume keying comprises interwoven ridges creating gaps between them on the build surface.

14. The method of claim 1, wherein the negative volume keying comprises interwoven grooves creating depressions on the build surface.

15. The method of claim 1 further comprising rotating the build substrate about a longitudinal axis of the build substrate.

16. The method of claim 15, wherein the depositing the material onto the build surface occurs while the build surface is rotating about the longitudinal axis.

17. The method of claim 1, further comprising removing at least a portion of the build substrate not in direct contact with the material deposited onto the build surface.

18. The method of claim 1, further comprising removing at least a portion of the build substrate in direct contact with the material deposited onto the build surface.

19. A system for additively manufacturing an article, comprising:
a build substrate having a longitudinal axis and a build surface, wherein the build surface includes at least one of a positive volume keying and a negative volume keying;
a rotary actuator operatively connected to the build substrate;
a deposition head positioned relative to the build substrate for depositing a material onto the build surface; and
a controller operatively connected to the rotary actuator and the deposition head, configured to synchronize rotation of the build substrate with the deposition of material to achieve a desired geometry of the article.

20. (canceled)

21. A method for controlling an additive manufacturing process, comprising:
receiving data pertaining to a desired geometry of an article;
determining a rotation speed and a deposition rate based on the data received;
instructing a rotary actuator to rotate a build substrate having a longitudinal axis and a build surface that includes at least one of a positive volume keying and a negative volume keying, based on the rotation speed that was determined; and
instructing a deposition head to deposit material onto the build surface in synchronization with the rotation of the build substrate, such that the material being deposited substantially conforms to the at least one of the positive volume keying and the negative volume keying, and defines a desired geometry of the article.

22. (canceled)
